(19) United States
(12) Patent Application Publication
(10) Pub. No.: US 2015/0193833 A1
(43) Pub. Date: Jul. 9, 2015

(54) Platform Independent System for Context-Related Advertisement Delivery and Display

(71) Applicant: YUME, INC., (US)

(72) Inventors: Ayyappan Sankaran, San Jose, CA (US); Jayant Kadambi, Palo Alto, CA (US); Matthew Shaver, Fremont, CA (US); Yogesh Dandekar, Cupertino, CA (US)

(73) Assignee: YUME, INC., Redwood City, CA (US)

(21) Appl. No.: 13/731,856

(22) Filed: Dec. 31, 2012

Related U.S. Application Data
(60) Provisional application No. 61/661,769, filed on Jun. 19, 2012.

(51) Int. Cl. G06Q 30/02

(52) U.S. Cl. CPC G06Q 30/0277

(57) ABSTRACT

A video display apparatus including a processor, non-volatile memory coupled to the processor storing binary code segments, an Internet interface coupled to the processor, and a video display coupled to the processor capable of displaying an advertisement received via the Internet. Example binary code segments include client code segments, board support package (BSP) code segments, player support package (PSP) code segments, application support package (ASP) code segments, and application code capable of interacting with the client code segments and the ASP code segments. A multi-platform advertising system provides a web server for concurrently communicating with two or more display devices to derived demographics of a common user for the purpose of delivering a targeted video advertisement.

### CROSS REFERENCE TO RELATED APPLICATION(S)

This application claims the benefit of U.S. Patent Application No. 61/661,769, filed on Jun. 19, 2012, which is incorporated herein by reference in its entirety.

### BACKGROUND

Video advertising has been around for many decades in the form of commercial television (“TV”) broadcasting. A TV video advertisement (a/k/a “commercial” or “ad”) is a segment of television programming produced and paid for by an organization to convey a message, e.g. the marketing of a product or service. Advertising revenue typically provides a significant portion of the funding for many privately owned television networks.

The demographics of the viewers of television programming, as measured by such companies as Nielsen Media Research, are often used as metrics for television advertisement placement. For example, if the demographics for a television show indicates that a significant percentage of the viewers are teenagers, advertisements can be selected that would market products or services that would likely be of interest to teenagers. Nonetheless, viewers tend to be significantly diverse and generally only relatively small segment of the audience viewing a commercial will have any interest in the good or service being presented.

Electronic commerce, often known as “e-commerce,” includes the buying and selling of products or services over electronic systems such as the Internet. The amount of trade conducted electronically has grown immensely with the widespread adoption of Internet technology. One particularly explosive area of growth in c-commerce is in the field of advertising and, in particular, video advertising on the Internet.

With the advent of hybrid televisions (also known as “Smart TV” and “Connected TV”) the opportunity to mix traditional television advertising with Internet delivered advertising has arisen. While the definitions for Smart TV can vary, it generally refers to the integration of the Internet and Web 2.0 features into modern television sets and set-top boxes, as well as the technological convergence between computers and such television sets and set-top boxes. Smart TV tends to have a much higher focus on online interactive media, Internet TV, on-demand streaming media and software applications (“apps”) and less of a focus on traditional broadcast media than was the case with previous generations of television sets and set-top boxes.

A Smart TV typically includes one or more processors (“CPUs”) which execute program instructions to perform the Smart TV functions. These program instructions (often referred to as “firmware”) are typically stored in a non-volatile semiconductor memory such as a ROM, EPROM, EEPROM, etc. The CPU and firmware form a part of what is often referred to as an “embedded system” which is used to digitally control various aspects of the Smart TV operation.

Despite the merging of television and Internet technologies, television advertising remains substantially as it has been for decades. That is, television advertising is a “lean back” experience, generally without user interaction, as opposed to Internet advertising which tends to be a “lean forward” experience, where the user interacts with the advertisement. Furthermore, valuable demographic information that could have been derived from Smart Television usage has not been applied to video advertisement delivery over the Internet.

It has become increasingly common for several hardware platforms (“devices”) to be accessed concurrently. For example, it is not uncommon for viewers to be watching television while using another device such as a laptop computer, tablet computer, or smart phone to browse the web or check email. However, such devices tend to operate independently thereby losing the synergies of device and cooperative network interactions.

These and other limitations of the prior art will become apparent to those of skill in the art upon a reading of the following descriptions and a study of the several figures of the drawing.

### SUMMARY

In an embodiment, set forth by way of example and not limitation, a non-volatile integrated circuit digital memory storing binary code segments includes client code segments, board support package (BSP) code segments, player support package (PSP) code segments, and application support package (ASP) code segments. In some example embodiment the client code segments, the BSP code segments, the PSP code segments and the ASP code segments are stored on one or more integrated circuit device.

In a further non-limiting example, the client code segments include PSP API code segments and BSP API code segments. In certain example embodiments, at least portions of the client code segments and the ASP code segments are accessible by an application executing on a digital processor. In further example embodiments, at least portions the BSP code segments and the PSP code segments are referenced by the client code segments.

In a further embodiment, set forth by way of example and not limitation, a video display apparatus includes a processor, non-volatile memory coupled to the processor storing binary code segments, an Internet interface coupled to the processor, and a video display coupled to the processor capable of displaying an advertisement received via the Internet. In this example, the binary code segments include client code segments, board support package (BSP) code segments, player support package (PSP) code segments, application support package (ASP) code segments and application code capable of interacting with the client code segments and the ASP code segments.

In a still further embodiment, set forth by way of example and not limitation, a multi-platform video advertising system includes a first video display device having a first firmware module including code segments facilitating communication over the Internet, a second video display device having a second firmware module including code segments facilitating communication over the Internet, and a video advertiser server system coupled to the Internet capable of communicating with the first video display device and the second video display device. The video advertising system is configured to determine whether the first video display device and the second video display device are related by a concurrent use in this non-limiting example. If so, the example video advertising system delivers a video advertisement to at least one of the first video display device and the second video display device using demographics associated with both the first video display device and the second video display device. The first video display device and the second video display device are capable of inter-device communication via, for example, the Internet, a wired connection or a wireless connection in another non-limiting example. In the case of Internet inter-device communication a facilitating web server may be employed.

These and other embodiments and other features disclosed herein will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, not limit, concepts disclosed herein. The drawings include the following figures:

FIG. 1 is a block diagram of a video display apparatus coupled to YuMe Services Server(s) and to Publisher Services Server(s) via the Internet;

FIG. 2 is a block diagram of an example hardware platform that can serve as the basis for a digital processing system, computer or server;

FIG. 3 is a block diagram of an example video display apparatus of FIG. 1;

FIG. 4 is an example YuMe Client initialization and ad playback sequence for non-cached ad playback;

FIG. 5 is an example YuMe Client initialization and ad playback sequence for cached ad playback:

FIG. 6 is a display screen of an example video display apparatus of FIG. 3;

FIG. 7 is a flow diagram of an example process for downloading video advertisements over the Internet:

FIG. 8 is a flow diagram of a FetchAd process of FIG. 7;

FIG. 9 is a flow diagram of a process for playing a cached advertisement; and

FIG. 10 is a block diagram of a multi-platform video advertising system.

### DETAILED DESCRIPTIONS

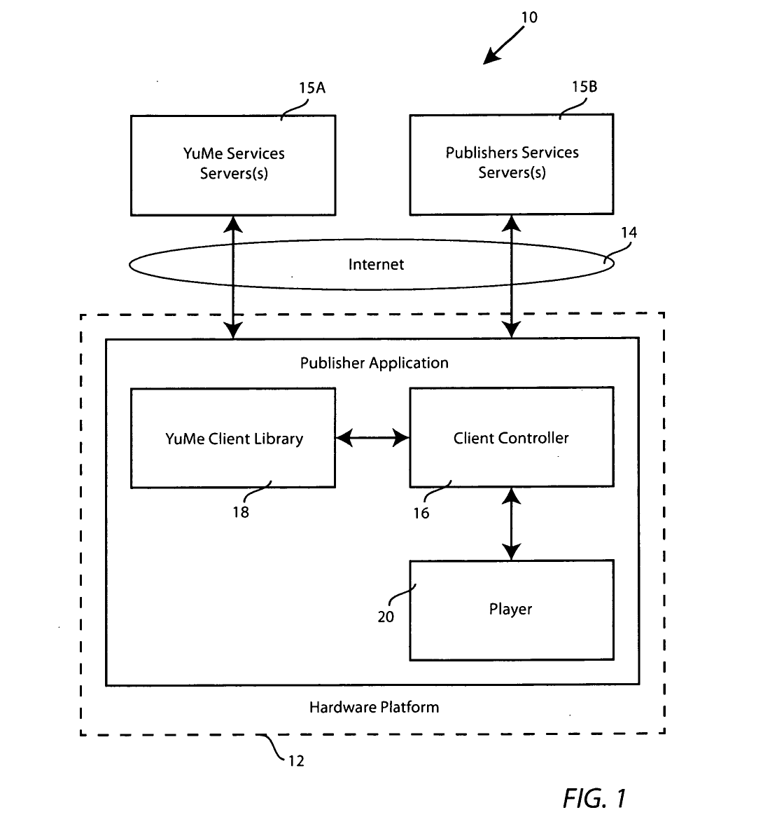

FIG. 1 illustrates, by way of example and not limitation, a system 10 for coupling a video display apparatus (“hardware platform”) 12 to the Internet 14. The system at 10 may further include other computers, servers or computerized systems such as YuMe Services Server(s) 15A, Publisher Services Server(s) 15B, proxies, etc. Alternatively, these other computers, servers or computerized systems can comprise a single server or as a number of real or virtual servers, such as a server farm and/or virtual servers, as will be appreciated by those of skill in the art.

As used herein, “YuMe” is used as an arbitrary label to aid in the understanding of the various embodiments, and is not to be an implication that the product, process, article or composition with which it is associated must be derived from YuMe, Inc., a Delaware Corporation, or any other particular entity. Furthermore, use of YuMe herein as an adjective or adverb does not act as a limitation with respect to any element or step disclosed herein. YUME® is a registered trademark of YuMe, Inc. for advertising services in International Class 035.

The hardware platform 12 includes, by way of non-limiting examples, electronics capable of displaying video advertisements on a video display or “screen” including digital processor(s) capable of executing code segments to implement various processes (embodied, for example, as firmware or software) as described herein. Some of these processes include, by way of non-limiting example, client controller processes 16, YuMe Client Library processes 18, and player processes 20. As will be discussed subsequently, the YuMe Client Library will be sometimes referred to as the YuMe embedded SDK.

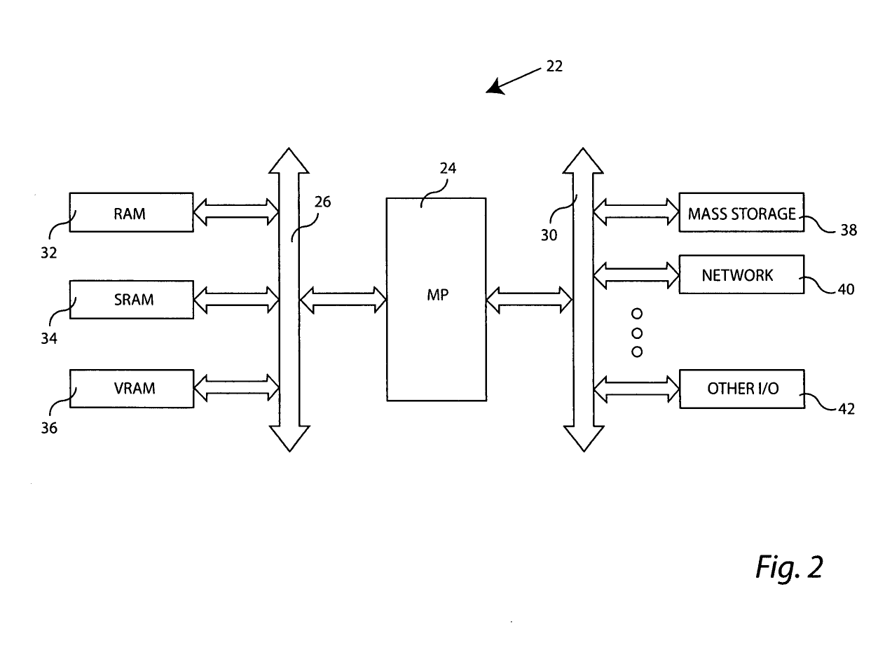

FIG. 2 is a simplified block diagram of a computer, digital processor and/or server 22 suitable for use in system 10. By way of non-limiting example, computer 22 includes a microprocessor 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of non-transitory computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

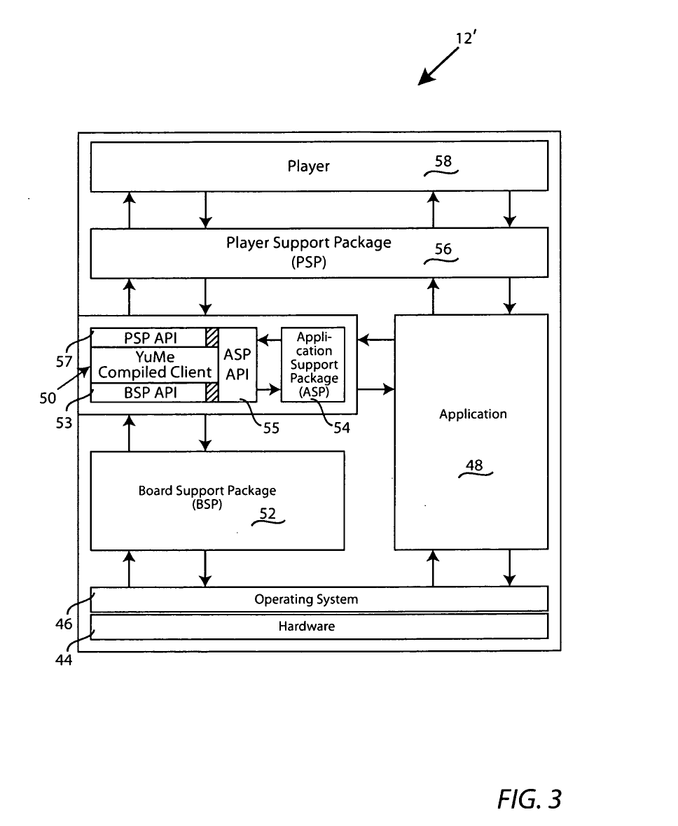

FIG. 3 is a block diagram of an example video display apparatus 12′ of FIG. 1 including hardware 44, Operating System 46, Application 48, YuMe Compiled Client 50, Board Support Package (BSP) 52. Application Support Package (ASP) 54, Player Support Package (PSP) 56, and Player 58.

As will be appreciated by those of skill in the art, the hardware 44 may be of the type illustrated in FIG. 2, by way of non-limiting example. The operating system 46 includes code segments that can, for example, execute on a microprocessor of the hardware 44 to provide an interface between the hardware 44 and higher-level software or firmware, such as Application 48 and BSP 52, which includes hardware-specific drivers.

Application 48, in this non-limiting example, can provide the basic functionality of the video display apparatus 12′. For example, it can digitally process and develop the video for display on a screen of the video display apparatus 12′. In this non-limiting example, Application 48 has bi-directional links with Operating System 46, ASP 54, and PSP 56.

YuMe Compiled Client 50, in this non-limiting example, forms a part of YuMe Client Library 18 of FIG. 1. The YuMe Compiled Client, in this example, provides an Application Program Interface (API) with each of BSP 52, ASP 54 and PSP 56. That is, the YuMe Compiled Client 50 has bi-directional links with BSP 52 via a BSP API 53, bi-directional links with ASP 54 via an ASP API 55 and bi-directional links with PSP 56 via a PSP API 57.

BSP 52 serves as an interface between the YuMe Compiled Client 50 and Operating System 46. ASP 54 serves as an interface between YuMe Compiled Client 50 and Application 48. PSP 56 serves as an interface between YuMe Compiled Client 50 and Player 58 as well as Application 48 and Player 58. As will also be discussed subsequently, this architecture provides hardware, operating system, application and player independence for the YuMe Compiled Client 50. ASP 54 provides application support for Application 54, as will also be discussed subsequently.

As will be appreciated by those of skill in the art, there are many practical applications for embedded applications such example Application 48. For example, the embedded applications can run in televisions, Blu-ray players, table computers, cellular telephones, etc. By “embedded application” it is meant that the application, comprising code segments, becomes, essentially part of the hardware of the device and is usually stored in non-volatile integrated circuit memory such as in a ROM, EPROM, EEPROM, etc. When code segments are stored in non-volatile integrated circuit memory, it is often referred to as “firmware” or “embedded software.” As used herein, the generic term “software” may include code segments stored in any media and, therefore, may at times refer to firmware or embedded software.

The YuMe Compiled Client 50 is typically provided as a binary file, i.e. it is typically provided to a manufacturer after it has been compiled by the supplier (YuMe in this example). The code segments represented by the binary file comprise, in this non-limiting example, at least a part of a “library” that provides resources and functionality to the Application 58. The YuMe Compiled Client 50 is customized by the supplier depending upon the type of video display apparatus.

In contrast, the BSP 52 and the PSP 56 may be provided as source code so that the manufacture can customize them prior to compilation and storage as firmware for the video display apparatus. This provides the manufacture with the freedom of changing its hardware, its operating system or its player without having to obtain a modified YuMe Compiled Client 50 from the supplier. This provides “platform independence” for the YuMe Complied Client 50, meaning that is can run on any hardware platform that conforms to its APIs. The customization of the BSP 52 and PSP 56, as well as the additional APIs provided by the ASP 54, are accomplished by a Software Developer's Kit (SDK) provided by YuMe. Since the resulting modified firmware is “embedded” into the devices' system, the resulting YuMe Client Library is also referred to herein as the “YuMe embedded SDK” or simply “embedded SDK.”

There are many advantages to the hardware and software platform independence of the YuMe Compiled Client 50. For one, it allows manufactures to change their hardware at will for cost or availability considerations. Also, it allows manufactures to change their players or their operating system, should they so desire. For example, the player can be changed from Flash to QuickTime or to a proprietary player of the manufacturer. Still further, the Application 48 can change (e.g. with the assistance of ASP 54 which can provide additions APIs for the application) without the need to change the YuMe Complied Client. Therefore, the architecture implementing the YuMe Compiled Client as described herein and as set forth by way of example in FIG. 3 is both hardware and software “platform” independent.

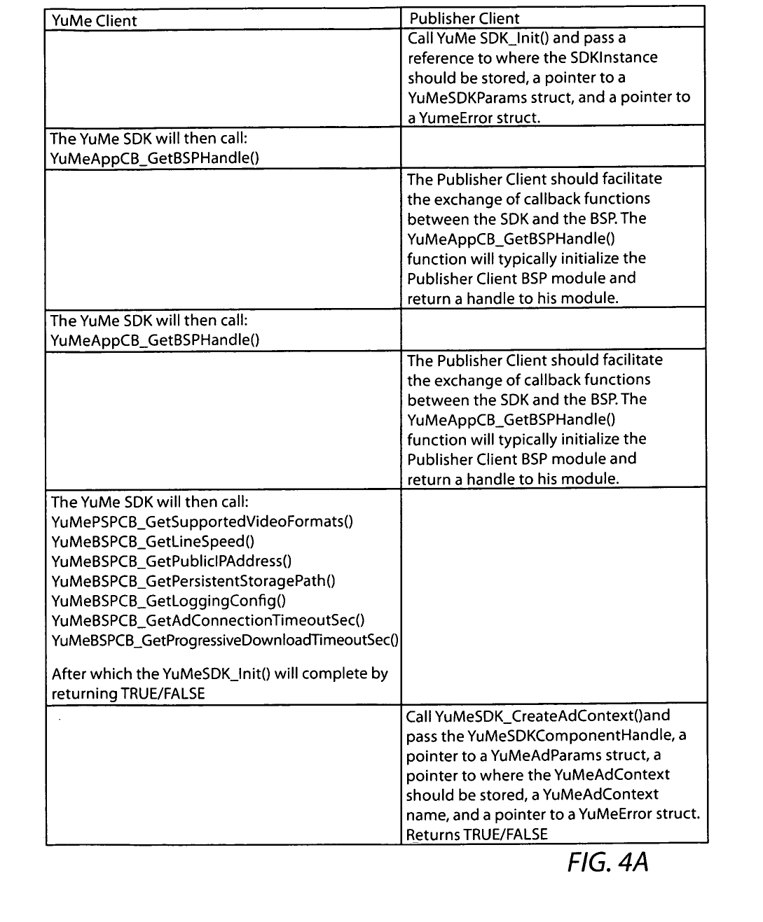

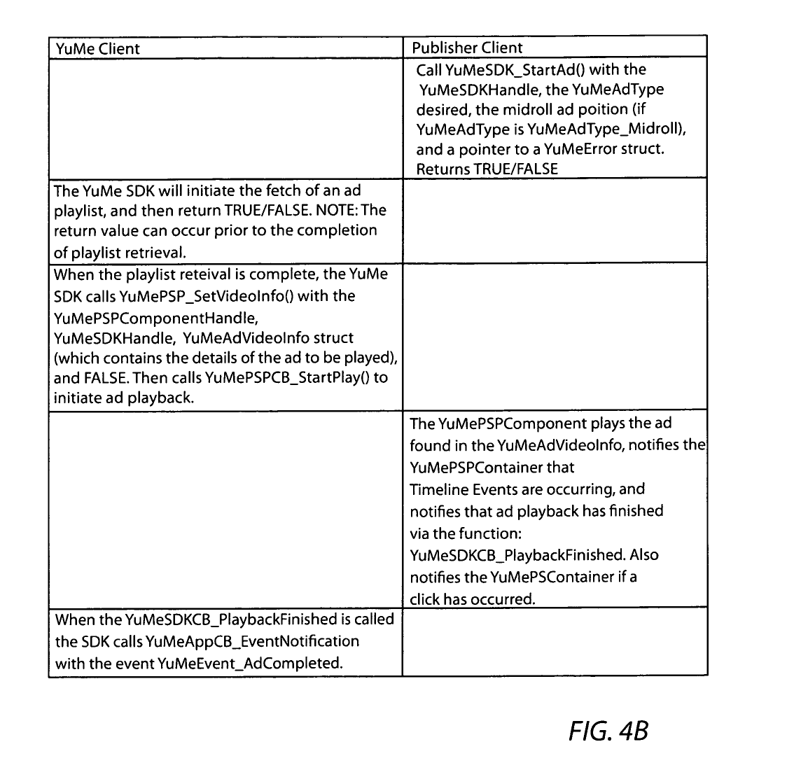

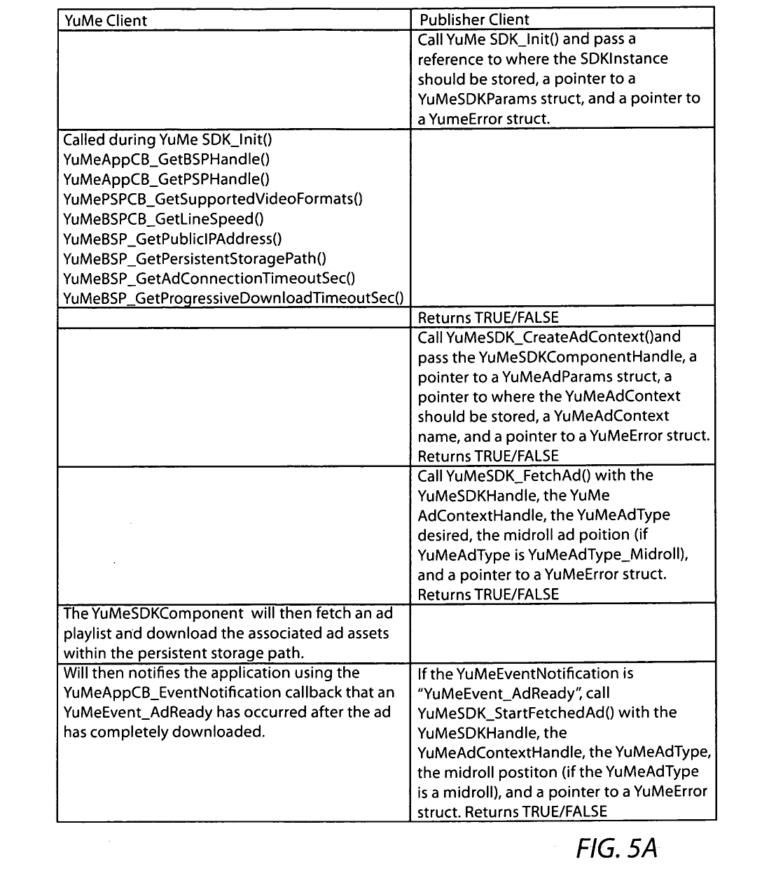

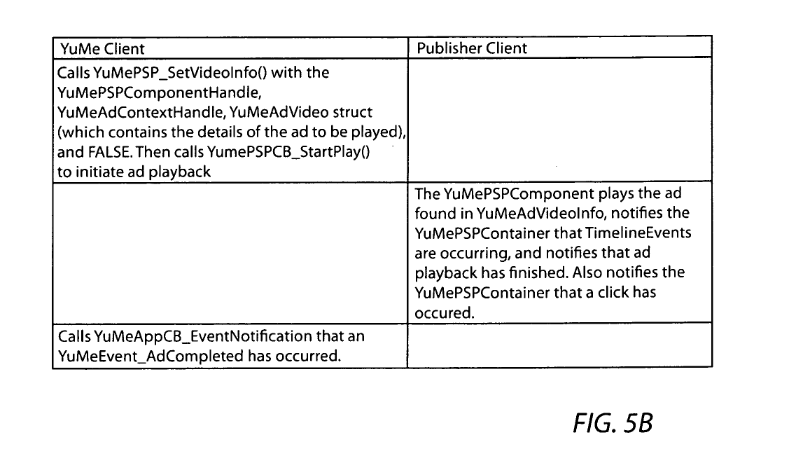

FIG. 4 illustrates an example YuMe Client initialization and ad playback sequence for non-cached ad playback. FIG. 5 illustrates an example YuMe Client initialization and ad playback sequence for cached ad playback. YuMe Compiled Client 50, which in this example is embodied in a number of library calls, is referred to as “YuMe Client” and the manufacture of the video display apparatus 12′ is referred to as “Publisher Client” in both of the examples of FIGS. 4 and 5. The interfaces with respect to the Publisher Client and the YuMe client will be discussed below.

Publisher Client Interfaces.

The YuMeSDKContainer, the YuMePSPComponent and the YuMeBSPComponent interface are implemented by the Publisher client. These three interfaces are used by the YuMeSDKComponent and the YuMePSPContainer to access publisher functions.

The YuMeSDKContainer interface allows the YuMeSDKComponent to:
Access the PSP handle
Access the BSP handle
Send ad events like click.
   The YuMePSPComponent interface allows the YuMePlayerContainer to:
Initiate playback of ad pre-rolls/mid-rolls/post-rolls
Get the accepted video formats
Tell the player to stop ad playback
   The YuMeBSPComponent allows the YuMeSDKComponent to:
Access line speed information
Retrieve the public IP address
Retrieve the path to the persistent storage location
Retrieve the size of the persistent storage
Access connection timeout settings

YuMe Client Interfaces

The YuMeSDKComponent interface allows the Publisher Client to:

Initialize the YuMe SDK.

Manage ad context(s)

Enable/disable ad caching of ad assets

Initiate the fetching of ads

Initiate the playback of a fetched ad

Initiate a non-pre-fetched ad request and ad playback sequence

□Initiate a stop ad request

Access flow control features

The YuMePSPContainer allows the YuMePSPComponent implemented by the Publisher client to:

indicate when video playback has finished

indicate when a click has occurred on the video or on a customization

inform the YuMPSPContainer of ad progress via TimelineEvents.

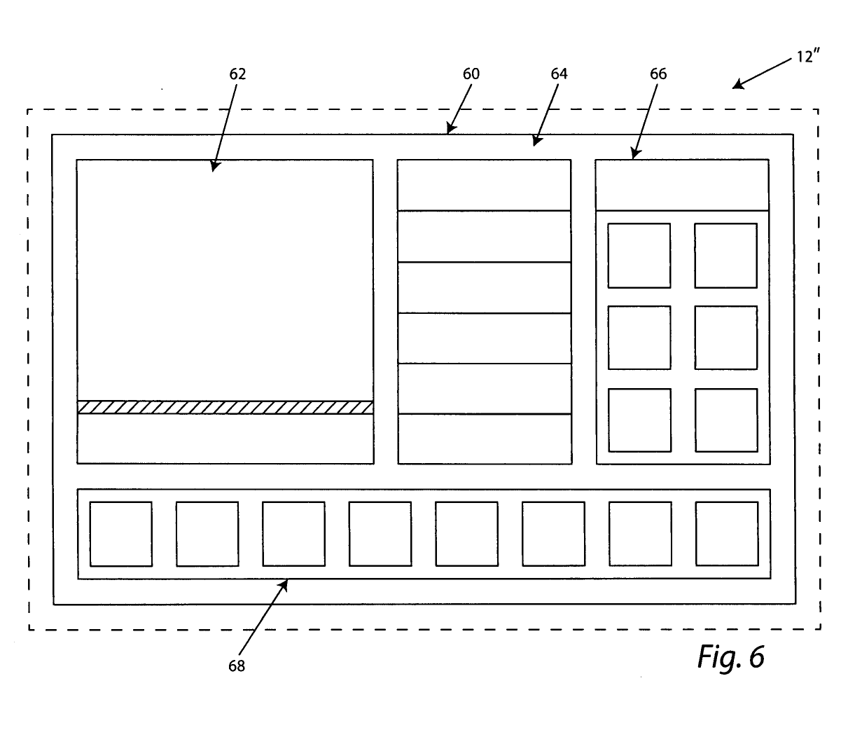

An example video display apparatus 12″ is illustrated in FIG. 6. This example is based upon an example Smart TV display having a viewing area (a/k/a “screen”) 60 which comprises a “live” viewing area 62, an additional services selection area 64, a television application selection area 66 and a selection bar 68. By way of non-limiting example, LG Electronics of Korea provides a similar type of product which will be generically be referred to as a “Smart TV.” With the addition of the YuMe Client Library to a Smart TV additional video advertising functionality can be provided.

Since the YuMe Client Library is embedded as firmware in the Smart TV, in this example, it becomes an extension to, and part of, the application running on the Smart TV. As such, it has full access to all aspects of the operation of the Smart TV, from the hardware to the software. As such, the YuMe Client Library can obtain finely detailed demographic and usage information concerning the hardware of which it forms a part.

Continuing with this example, when the Smart TV with YuMe Client Library is powered up, the embedded SDK in the Smart TV's code begins to execute. Any advertising experience outside of the scope of the standard application of the Smart TV is handled by the embedded SDK. For example, the player can be “skinned” with an advertisement related to the context and/or demographics of the presumed viewer(s). The embedded SDK can also opportunistically use idle time, e.g. when an app is being downloaded, to download and cache video advertisements.

The embedded SDK is advantageous in that it is integrated at the device level and can monitor the entire user experience. For example, cross-application data can be used. Also, viewing history, Internet browsing, or social media interaction can be used to derive preference data and/or viewer demographics. This data can be communicated to advertising servers via the Internet so that appropriate video advertisements can be selected for delivery to the device (the Smart TV in this example).

For example, if the Smart TV is being used to view a movie at the Netflix® website, the embedded SDK can monitor the category of movie and make certain assumptions about the viewer. For example, if the movie is a travel documentary, it can be assumed that the view is interested in travel, and an appropriate video advertisement might for luggage. This may be further reinforced if the view watches the travel channel on television, or orders a TV app related to travel.

Since certain devices, such as Smart TV's, may be used by multiple individuals, the embedded SDK, and the advertising server(s) with which it communicates, can attempt to determine which users, or groups of users, are using the Smart TV at a particular time. Video advertisements can then be selected as appropriate to the viewing audience.

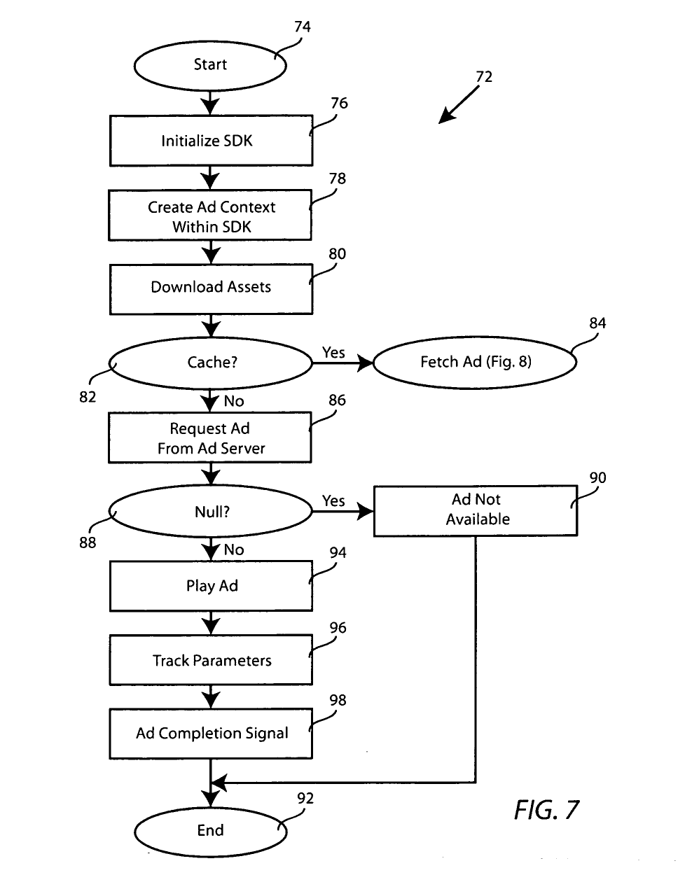

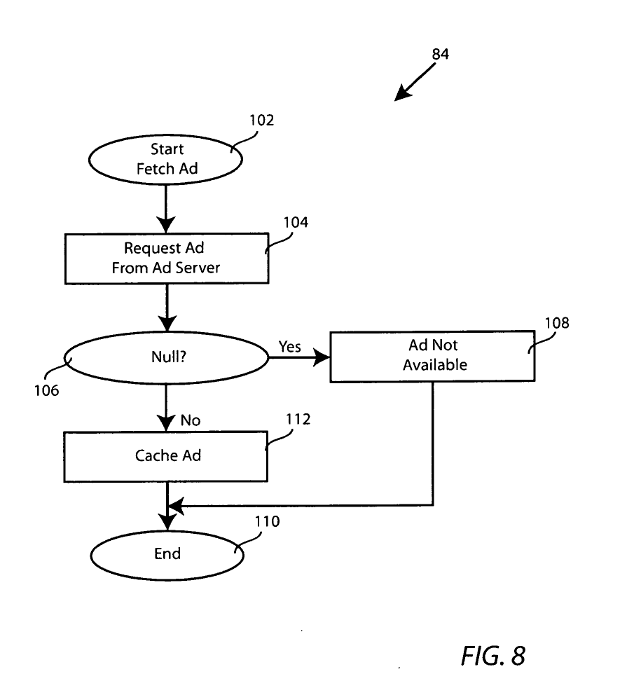

FIG. 7 is a flow diagram of an example process 72 for downloading video advertisements over the Internet. Process 72 starts at 74 and, in an operation 76, the embedded SDK is initialized. Next, in an operation 78, an ad context is created within the SDK. An operation 80 downloads assets, and a decision operation 82 determines whether the assets are to be cached for later viewing or are to be played immediately. If the assets are to be cached, an operation 84 “FetchAd” (FIG. 8) is implemented.

If operation 82 determines that the assets are not to be cached, an “ad” is requested from an “ad server” in an operation 86. If no ad is returned (i.e. a “null” is the result of the request), the system is informed that an ad is not available in an operation 90 and the process 72 ends at 92. However, if an ad is returned, it is played in an operation 94. Operation 96 tracks the parameters of the play (e.g. if it is played all the way through) and an ad completion signal is provided by operation 98 after the ad is done playing.

FIG. 8 illustrates the process 84 of FIG. 7 in greater detail. FetchAd starts at 102 and, in an operation 104, an ad is requested from an ad server. Decision operation 106 determines if the return of an ad is a “null” and, if so, and operation 108 informs the system that an ad is not available. Otherwise, an operation 112 caches the ad for potential later playback. The operation 84 ends at 110.

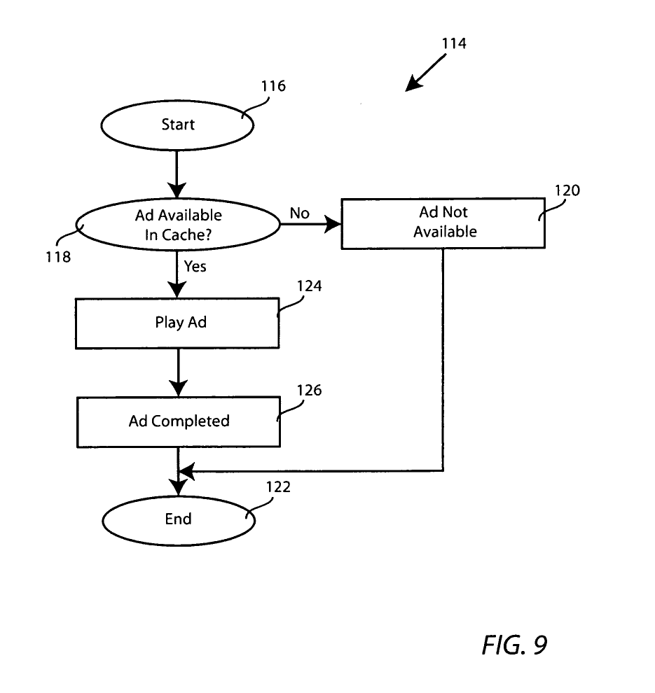

FIG. 9 illustrates a process 114 for playing a cached ad. Process 114 starts at 116 and, in a decision operation 118, it is determined if there is an ad available in the cache. If not, an operation 120 informs the system that an ad is not available and process 114 ends at 122. If there is a cached ad available, an operation 124 plays the ad, and an operation 126 informs the system when the ad play has been completed.

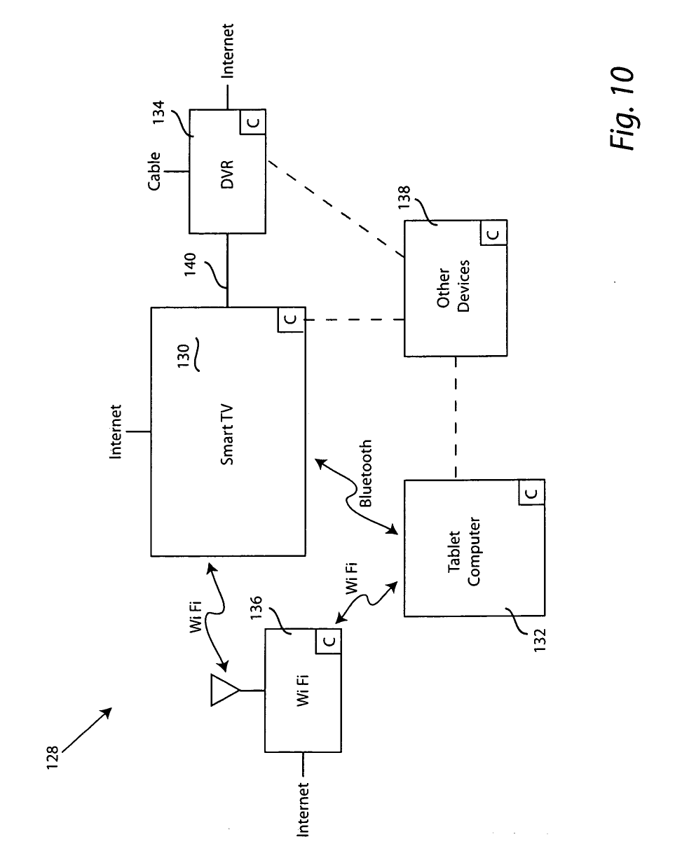

FIG. 10 is a block diagram of a multi-platform video advertising system 128, set forth by way of example and not limitation. By “multi-platform” it is meant that a YuMe embedded SDK “C” is integrated into one or more devices, including but not limited to video display apparatus. In this non-limiting example, these devices include a Smart TV 130, a tablet computer 132, a DVR 134, a WiFi “hot spot” 136, and/or other devices 138 (e.g. a laptop computer), all with the YuMe embedded SDK C.

It is not un-common for a user (“viewer”) to be accessing several hardware platforms (devices) concurrently. For example, a user may be watching or interacting with Smart TV 130 at the same time that he is using a tablet computer 132. Since, in this example, both devices are provided with the YuMe embedded SDK. C, there is the opportunity to derive additional usage and demographic information concerning the concurrent user and to provide the user with targeted video advertisements.

As seen in the non-limiting example of FIG. 10, a multi-platform video advertising system can include a first video display device (e.g. Smart TV 130) having a first firmware module including code segments C of the embedded SDK facilitating communication over the Internet and a second video display device (e.g. tablet computer 132) having a second firmware module including code segments C facilitating communication over the Internet. Tablet computers, such as tablet computer 132, are well adapted for social networking and are often used for such a purpose while concurrently using the Smart TV 130, by way of additional non-limiting example. In another example, Smart TV 130 is used for social networking.

A video advertiser server system can be coupled to the Internet to communicate with the Smart TV 130 and the Tablet Computer 132 via their respective embedded SDKs. In a further non-limiting example, the video advertising server system is configured to determine whether the Smart TV 130 and the Tablet Computer 132 are related by their concurrent use. If the two devices are considered to be related (e.g. it is deduced that the same user is using both devices simultaneously) the video advertising system can deliver a video advertisement to either or both of the devices using usage and demographic information derived from both devices.

In a further non-limiting example, the devices are capable of inter-device communication, such as via the Internet, by a hardwire connection 140 as illustrated between Smart TV 130 and DVR 134, and/or wirelessly such as by WiFi or Bluetooth. Other forms of communication are also possible, such as audio or infrared. For example, the tablet computer 132 can use a microphone to monitor audio from the Smart TV 130 which is used to determine that the two devices are “related”, i.e. they are in the same room and exposed to the same audio signals. In another example, infrared (I/R) signals can be used to communicate between devices that are in line-of-sight of each other.

In another non-limiting example, the Tablet Computer 132 and the Smart TV 130 both communicate over the Internet with a web server (not shown in FIG. 10, but well known to those of skill in the art). The web server can perform many functions, including facilitating social networking, facilitating communication between the Tablet Computer 132 and the Smart TV 130, using inputs from both video display devices to enhance the user's viewing experiences, etc., by way of non-limiting examples.

Although various embodiments have been described using specific terms and devices, such description is for illustrative purposes only. The words used are words of description rather than of limitation. It is to be understood that changes and variations may be made by those of ordinary skill in the art without departing from the spirit or the scope of any embodiments described herein. In addition, it should be understood that aspects of various other embodiments may be interchanged either in whole or in part. It is therefore intended that the claims herein and hereafter presented be interpreted in accordance with their true spirit and scope and without limitation or estoppel.

What is claimed is:

1-8. (canceled)

9. A multi-platform video advertising system comprising:
a first video display device having a first firmware module including code segments facilitating at least one of a wired and a wireless connection to the Internet via a first network interface;
a second video display device having a second firmware module including code segments facilitating a wireless connection to the Internet via a second network interface that is separate from the first interface; and
a video advertiser server system coupled to the Internet capable of communicating with the first video display device and the second video display device via a third network interface that is separate from the first interface and the second interface, whereby the video advertiser server system can communicate directly with each of the first video display device and the second video display device without going through the other of the first video display device and the second video display device, the video advertising system being configured to determine whether the first video display device and the second video display device are related by a concurrent use by deducing that a same user is using both the first video display device and the second video display device simultaneously, the video advertising system being configured to deliver a video advertisement to at least one of the first video display device and the second video display device using demographics associated with both the first video display device and the second video display device if it is determined that the first video display device and the second video display device are related by the concurrent use.

10. A multi-platform advertising system as recited in claim 9 wherein the first video display device and the second video display device are capable of inter-device communication.

11. A multi-platform advertising system as recited in claim 10 wherein the inter-device communication is via the Internet.

12. A multi-platform advertising system as recited in claim 10 wherein the inter-device communication is via a wired connection.

13. A multi-platform advertising system as recited in claim 10 wherein the inter-device communication is via a wireless communication.

14. A multi-platform advertising system as recited in claim 13 wherein the wireless communication comprises WiFi.

15. A multi-platform advertising system as recited in claim 13 wherein the wireless communication comprises Bluetooth.

16. A multi-platform advertising system as recited in claim 9 wherein the first video display device is a Smart TV.

17. A multi-platform advertising system as recited in claim 16 wherein the second video display device is one of a tablet computer, a laptop computer and a smart phone.

18. A multi-platform advertising system as recited in claim 17 wherein both the first video display device and the second video display device communicate over the Internet with a web server.

19. A multi-platform advertising system as recited in claim 18 wherein the web server facilitates social networking when the first video display device and the second video display device are related by the concurrent use.

20. A multi-platform advertising system as recited in claim 18 wherein the web server facilitates communication between the first video display device and the second video display device over the Internet.

21. A multi-platform video advertising system comprising:
a Smart TV having a first firmware module including code segments facilitating communication over the Internet via a first network interface;
a mobile computing device having a second firmware module including code segments facilitating communication over the Internet via a second network interface that is separate from the first network interface, wherein the mobile computing device is one of a tablet computer, a laptop computer and a smart phone; and
a video advertiser server system coupled to the Internet capable of communicating with the Smart TV and the mobile computing device via a third network interface that is separate from the first interface and the second interface, whereby the video advertiser server system can communicate directly with one of the first video display device as facilitated by the first firmware module and the second video display device as facilitated by the second firmware module without going through the other of the first video display device and the second video display device, the video advertising system being configured to determine whether the Smart TV and the mobile computing device are related by a concurrent use by deducing that a same user is using both the Smart TV and the mobile computing device simultaneously, the video advertising system being configured to deliver a video advertisement to at least one of the Smart TV and the mobile computing device using demographics associated with both the Smart TV and the mobile computing device if it is determined that the Smart TV and the mobile computing device are related by the concurrent use.

22. A multi-platform video advertising system as recited in claim 21 wherein the Smart TV and the mobile computing device can engage in local communication.

23. A multi-platform video advertising system as recited in claim 22 wherein the Smart TV and the mobile computing device communicate locally with a hardwire connection.

24. A multi-platform video advertising system as recited in claim 22 wherein the Smart TV and the mobile computing device communicate locally with a wireless connection.

25. A multi-platform video advertising system as recited in claim 24 wherein the wireless connection uses one of a Bluetooth and a WiFi communication protocol.

26. A multi-platform video advertising system as recited in claim 24 wherein the wireless connection uses an infrared (I/R) signal.

27. A multi-platform video advertising system as recited in claim 21 wherein the mobile computing device detects an output of the Smart TV.

28. A multi-platform video advertising system as recited in claim 27 wherein the output of the Smart TV is an audio signal detected by a microphone of the mobile computing device.
